(19) United States
(12) Patent Application Publication
(10) Pub. No.: US 2023/0174022 A1
(43) Pub. Date: Jun. 8, 2023

(54) CLEANING SOLUTION SUPPLY DEVICE FOR A FUEL CELL VEHICLE

(71) Applicants: HYUNDAI MOTOR COMPANY, Seoul (KR); KIA CORPORATION, Seoul (KR)

(72) Inventor: Yun Jeong Shim, Donghae-si (KR)

(73) Assignees: HYUNDAI MOTOR COMPANY, Seoul (KR); KIA CORPORATION, Seoul (KR)

(21) Appl. No.: 17/993,084

(22) Filed: Nov. 23, 2022

(30) Foreign Application Priority Data
Dec. 7, 2021 (KR) 10-2021-0173862

(51) Int. Cl. B60S 1/48; B60S 1/50; B60S 1/56

(52) U.S. Cl. CPC B60S 1/481; B60S 1/50; B60S 1/56

(57) ABSTRACT

Disclosed is a cleaning solution supply device, and more particularly, a cleaning solution supply device for a fuel cell vehicle. The cleaning solution supply device includes a housing, a mixing pump mounted on the housing and configured to receive water generated during power generation by a fuel cell stack and to mix the received water with a cleaning agent stored in the housing, and a supply line configured to discharge a cleaning solution obtained by mixing the received water with the cleaning agent to an outside of the housing.

### CROSS-REFERENCE TO RELATED APPLICATION

This application claims under 35 U.S.C. § 119(a) the benefit of and priority to Korean Patent Application No. 10-2021-0173862, filed on Dec. 7, 2021, the entire contents of which are incorporated herein by reference.

### BACKGROUND

### (a) Technical Field

The present disclosure relates to a cleaning solution supply device. More particularly, it relates to a cleaning solution supply device for a fuel cell electric vehicle.

### (b) Background Art

A fuel cell is an eco-friendly energy source that generates electricity through an electrochemical reaction between hydrogen and oxygen. In consideration of this eco-friendly aspect of fuel cells, research on the fuel cells has been actively conducted. Particularly, efforts have been continuously made to develop a vehicle to which the fuel cells are applied in the automotive industry.

In general, a fuel cell vehicle includes a fuel cell stack formed by stacking a plurality of unit cells. In the fuel cell stack, air and hydrogen gas are supplied to each unit cell of the plurality of unit cells. Then the supplied air and hydrogen gas undergo electrochemical reaction. During this reaction process, water is essentially generated.

However, the water generated in the reaction process may interfere with the flow of oxygen and hydrogen in the fuel cell stack. Particularly, when the ambient temperature is low, the fuel cell may be damaged due to frozen water. Accordingly, the fuel cell vehicle includes a water discharge device configured to discharge the generated water to the outside of the vehicle.

Normally, when the vehicle is turned off, residual water of the fuel cell stack is discharged through the water discharge device. However, we have discovered that when the ambient temperature is low, the water discharged to the outside of the vehicle may freeze on the road or parking lot.

The above information disclosed in this Background section is only to enhance understanding of the background of the present disclosure and therefore it may contain information that does not form the prior art that is already known to a person of ordinary skill in the art.

### SUMMARY OF THE DISCLOSURE

The present disclosure provides a cleaning solution supply device capable of efficiently treating residual water generated in a fuel cell vehicle.

The objects of the present disclosure are not limited to the above-mentioned object, and other objects not yet mentioned should be clearly understood by those of ordinary skill in the art to which the present disclosure pertains (hereinafter referred to as “those skilled in the art”) from the following descriptions.

In one aspect of the present disclosure, a cleaning solution supply device includes: a housing, and a mixing pump which is mounted on the housing and configured to receive water generated during power generation of a fuel cell stack and to mix the water with a cleaning agent stored in the housing. The cleaning solution supply device further includes a supply line configured to discharge a cleaning solution obtained by mixing the water with the cleaning agent to an outside of the housing.

Other aspects and embodiments of the present disclosure are discussed infra.

It is understood that the term “vehicle” or “vehicular” or other similar terms as used herein are inclusive of motor vehicles in general such as passenger automobiles including sport utility vehicles (SUVs), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the present disclosure are discussed infra.

### BRIEF DESCRIPTION OF THE DRAWINGS

The above and other features of the present disclosure are described in detail with reference to certain exemplary embodiments thereof illustrated in the accompanying drawings which are given hereinbelow by way of illustration only, and thus are not limitative of the present disclosure, and wherein:

FIG. 1 is a schematic view illustrating an exhaust system of a fuel cell vehicle;

FIG. 2 is a penetrating view showing the inside of a silencer of the exhaust system of FIG. 1;

FIG. 3 is a cross-sectional view of FIG. 2;

FIGS. 4 and 5 are views showing a cleaning solution supply device, the inside of which is visible, according to an embodiment of the present disclosure;

FIG. 6 is a view illustrating a cleaning solution pump of the cleaning solution supply device according to one embodiment; and

FIG. 7 is a view conceptually illustrating an operation control of the cleaning solution supply device according to one embodiment of the present disclosure.

It should be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes should be determined in part by the particular intended application and use environment.

In the figures, reference numbers refer to the same or equivalent parts of the present disclosure throughout the several figures of the drawing.

### DETAILED DESCRIPTION

Specific structural or functional descriptions made in connection with the embodiments of the present disclosure are merely illustrative for the purpose of describing embodiments according to the concept of the present disclosure, and the embodiments according to the concept of the present disclosure may be implemented in various forms. Further, it should be understood that the present description is not intended to limit the present disclosure to those embodiments. On the contrary, the present disclosure is intended to cover not only the embodiments, but also various alternatives, modifications, equivalents and other embodiments, which may be included within the spirit and scope of the present disclosure.

Meanwhile, in the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for the description of relationships between components, that is, “between” and “directly between” or “adjacent to” and “directly adjacent to,” should be interpreted in the same manner.

The same reference numerals represent the same components throughout the specification. Additionally, the terms in the specification are used merely to describe embodiments and are not intended to limit the present disclosure. In this specification, an expression in a singular form also includes a plural form, unless otherwise clearly specified in context. As used herein, expressions such as “comprise” and/or “comprising” do not exclude the presence or addition of one or more components, steps, operations, and/or elements other than those described.

When a component, device, element, or the like of the present disclosure is described as having a purpose or performing an operation, function, or the like, the component, device, or element should be considered herein as being “configured to” meet that purpose or to perform that operation or function.

An object of the present disclosure is to provide a cleaning solution supply device configured to collect water generated in an exhaust system of a fuel cell vehicle and to utilize the collected water, thereby efficiently using residual water generated, as a by-product, in the fuel cell vehicle.

Hereinafter, the present disclosure is described in detail with reference to the accompanying drawings.

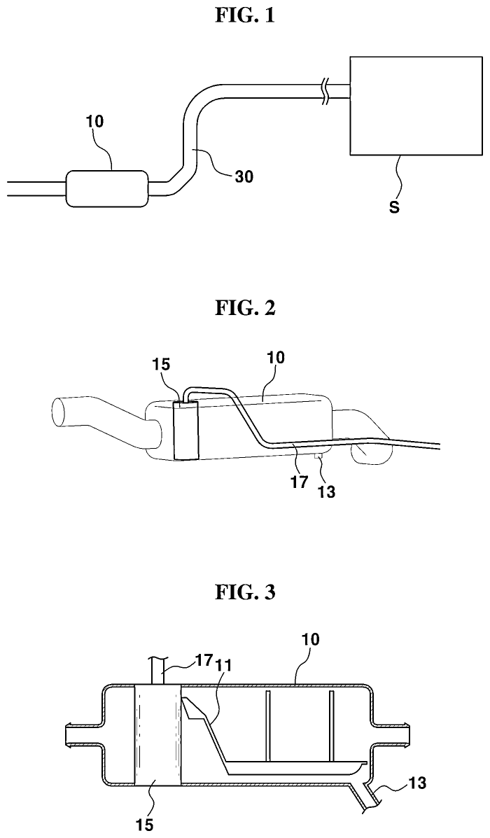

In one embodiment of the present disclosure, a cleaning solution supply device 1 may receive water from a silencer 10 of an exhaust system. The above-described water discharge device configured to discharge residual water generated in the fuel cell vehicle is provided in the exhaust system of a fuel cell system. As shown in FIG. 1, an exhaust path 30 is connected to an outlet of a fuel cell stack S, and the silencer 10 configured to reduce exhaust noise is provided in the exhaust path 30.

Air, hydrogen, and water vapor are discharged from the fuel cell stack S through the exhaust path 30. In detail, the air and hydrogen may be recirculated to the fuel cell stack S, and the water vapor may be condensed through the silencer 10 and may be discharged to the outside of the vehicle. A part of the water vapor flowing into the silencer 10 may be condensed into water and may be stored in the silencer 10. For example, as shown in FIGS. 2 and 3, the silencer 10 may include a water storage 11 configured to store the water condensed in the silencer 10. Further, the water stored in the water storage 11 is configured to be discharged to the outside of the silencer 10 through an outlet 13 when necessary. The outlet 13 may include a device, such as a valve capable of opening the outlet 13 when necessary, and the water may be stored in the water storage 11.

According to one embodiment of the present disclosure, the silencer 10 includes a water pumping unit 15 capable of moving the water stored in the water storage 11. In addition, a directing tube 17 is connected to the silencer 10 so that water pumped through the water pumping unit 15 is directed to the outside of the silencer 10 through the directing tube 17.

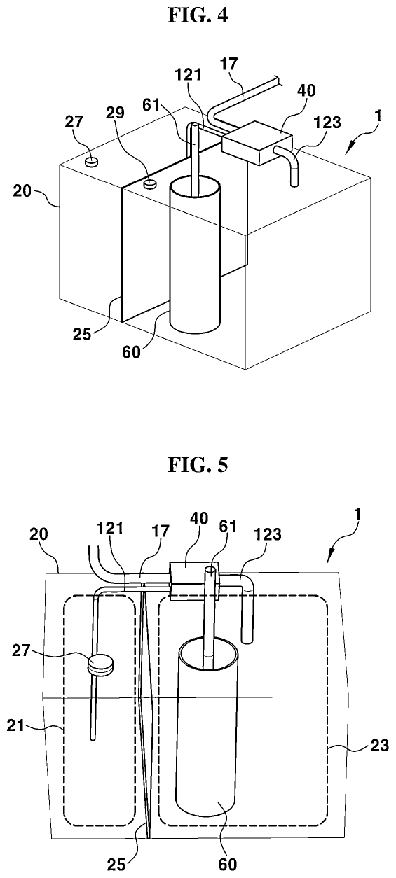

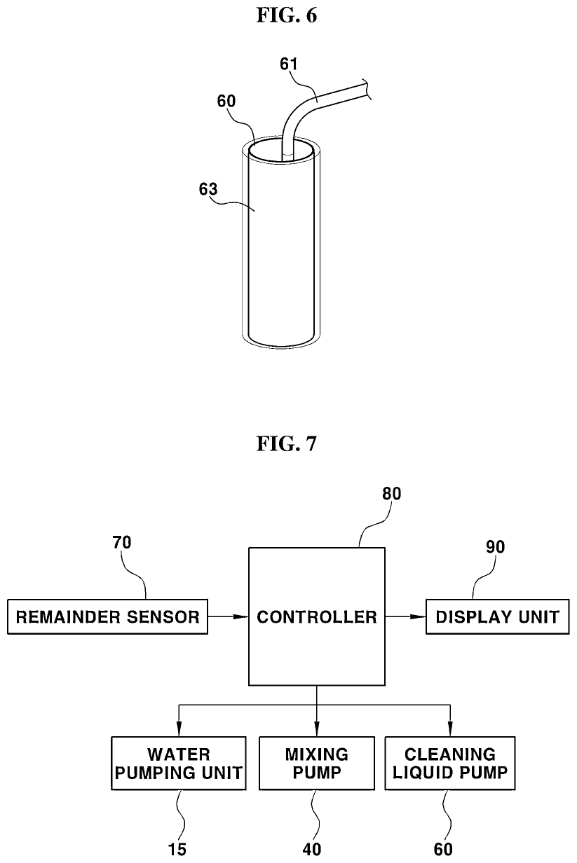

Referring to FIGS. 4 and 5, the cleaning solution supply device 1 is configured to be in fluid communication with the directing tube 17. The cleaning solution supply device 1 is configured to receive water in the silencer 10 flowing through the directing tube 17.

The cleaning solution supply device 1 includes a housing 20. The housing 20 may include a space divided into at least two spaces. In an embodiment, the housing 20 may include a cleaning agent storage 21 and a mixed solution storage 23. The cleaning agent storage 21 and the mixed solution storage 23 are spaces separated from each other, and the cleaning agent storage 21 and the mixed solution storage 23 may store different substances, respectively. In an embodiment, the housing 20 may include a screen member 25 capable of forming two separate independent spaces.

The cleaning agent may be stored in the cleaning agent storage 21. For example, the cleaning agent in the cleaning agent storage 21 may be replenished through a replenishment path 27 formed in the housing 20. In an embodiment, the cleaning agent may be any one of a solid, a liquid, and a mixture thereof. There is no particular limitation on the formulation of the cleaning agent, and the same may be a soluble material.

The mixed solution storage 23 may store a cleaning solution generated by mixing a cleaning agent and water. Specifically, the mixed solution storage 23 may store the cleaning solution generated by mixing the cleaning agent stored in the cleaning agent storage 21 and water discharged from the silencer 10. In some embodiments, the housing 20 includes an inlet 29. The inlet 29 may be configured to communicate with the mixed solution storage 23. In detail, when residual water in the silencer 10 is insufficient, the inlet 29 is used to allow water from the outside to flow into the mixed solution storage 23.

According to an embodiment of the present disclosure, the cleaning solution supply device 1 includes a mixing pump 40 provided to produce the cleaning solution. In an embodiment, the mixing pump 40 includes at least two inlets. One (e.g., a first inlet) of the inlets of the mixing pump 40 is connected to the directing tube 17 to allow water from the directing tube 17 to flow thereinto, while the other inlet (e.g., a second inlet) among the two inlets is connected to a cleaning agent line 121 to receive the cleaning agent from the cleaning agent storage 21. The cleaning agent line 121 is a path through which the cleaning agent in the cleaning agent storage 21 moves up to the mixing pump 40. In some embodiments, the directing tube 17 and the cleaning agent line 121 may be provided with different diameters. In order to obtain a predetermined concentration of the cleaning agent, the directing tube 17 and the cleaning agent line 121 may be configured to have different diameters. In an embodiment, the mixing pump 40 may be mounted on the outside of the housing 20.

In some embodiments, two individual pumps may be provided instead of the mixing pump 40. Specifically, one of the two individual pumps is connected to the directing tube 17, and the other pump among the two individual pumps is connected to the cleaning agent line 121. Further, the outlet of each individual pump is connected in fluid communication with the mixed solution storage 23. The concentration of the mixed solution or cleaning solution may be adjusted by changing the pumping speed and flow rate of each individual pump.

The mixed solution of water pumped through the mixing pump 40 and the cleaning agent is directed to the mixed solution storage 23. To this end, in an embodiment, the mixed solution line 123 is connected to the outlet of the mixing pump 40. The mixed solution line 123 is connected in fluid communication with the mixing pump 40 and the mixed solution storage 23. The cleaning solution, which is a mixed solution of water and the cleaning agent mixed through the mixing pump 40, flows along the mixed solution line 123 and is stored in the mixed solution storage 23.

The mixed solution storage 23 includes a cleaning solution pump 60. The cleaning solution pump 60 is configured to discharge the mixed solution or the cleaning solution stored in the mixed solution storage 23 to the outside of the mixed solution storage 23. A supply line 61 is provided at the outlet of the cleaning solution pump 60, and the cleaning solution pumped by the cleaning solution pump 60 may flow along the supply line 61 and may be supplied to a target location. In some implementations, the supply line 61 may be connected to a sensor cleaning system of the vehicle. In some implementations, the supply line 61 may be connected to a windshield cleaning device configured to clean a windshield of the vehicle. In other words, in one form, the cleaning solution produced by mixing water discharged from the fuel cell vehicle and the cleaning agent is supplied to various locations where cleaning is required in the vehicle, thereby making it possible to efficiently treat residual water.

As shown in FIG. 6, in an embodiment, a cleaning solution filter 63 may be provided in the mixed solution storage 23. Particularly, the circumference of the cleaning solution pump 60 may be surrounded by the cleaning solution filter 63. The cleaning solution filter 63 may be provided in the mixed solution storage 23 to inhibit or prevent the cleaning solution pump 60 or the supply line 61 from being blocked by the inflow of foreign substances.

As shown in FIG. 7, in some embodiments, the cleaning solution supply device 1 may include a remainder sensor 70 capable of detecting at least one of the residual amount of the cleaning agent in the cleaning agent storage 21 or the residual amount of the cleaning solution in the mixed solution storage 23. Desirably, the remainder sensor 70 may be provided in each of the cleaning agent storage 21 and the mixed solution storage 23, thereby detecting both the residual amount of the cleaning agent in the cleaning agent storage 21 and the residual amount of the cleaning solution in the mixed solution storage 23. As a non-limiting example, the remainder sensor 70 may be a water level sensor, a weight sensor, and the like, but is not limited thereto. Another sensor may be used as long as the same may detect the residual amount of material in the space.

The cleaning solution supply device 1 may further include a controller 80. The controller 80 may include a plurality of controllers configured to individually control the water pumping unit 15, the mixing pump 40, and the cleaning solution pump 60, or may be an integrated controller configured to control all of the water pumping unit 15, the mixing pump 40, and the cleaning solution pump 60.

The controller 80 may produce the cleaning solution and may perform a control operation to direct the produced cleaning solution so that the same is provided to a target location in the vehicle. Specifically, the controller 80 may drive the mixing pump 40 to produce the cleaning solution. When the mixing pump 40 comprises two individual pumps, the controller 80 may control the pump flow rates of the pump for the cleaning agent and the pump for water to adjust the concentration of the mixed solution or the cleaning solution. In addition, the controller 80 may drive the cleaning solution pump 60 to allow the cleaning solution to flow to the supply line 61, and may supply the cleaning solution to a target location along the supply line 61.

The controller 80 may receive information on the residual amount of substances in the cleaning agent storage 21 and the mixed solution storage 23 from the remainder sensor 70. As a non-limiting example, when the amount sensed by the remainder sensor 70 is less than 10 percent of the total volume of the cleaning agent storage 21 or the mixed solution storage 23, the controller 80 may determine that the amount in the cleaning agent storage 21 or the mixed solution storage 23 is insufficient. When any one of the amount of the cleaning agent in the cleaning agent storage 21 and the amount of the cleaning solution in the mixed solution storage 23 is insufficient based on the information received from the remainder sensor 70, the controller 80 may notify the driver of the shortage thereof. For example, the controller 80 may display a notification about the shortage of the cleaning agent or the cleaning solution on a display unit 90, such as a cluster of the vehicle. In an embodiment, the controller 80 may provide a notification to the display unit 90 when the amount of the cleaning agent is insufficient. In an embodiment, the controller 80 drives the mixing pump 40 when the amount of the cleaning solution is insufficient so that the cleaning solution is replenished in the mixed solution storage 23. There may be a situation where the amount of the cleaning solution appears insufficient even though the controller 80 has repeatedly driven the mixing pump 40. In this case, the controller 80 may determine that water is insufficient and may provide a notification about the shortage of water to the display unit 90.

Further, when the residual amount of the mixed solution storage 23 is excessive, the controller 80 performs a control operation to discharge the residual amount thereof. In an embodiment, the controller 80 forcibly drives the cleaning solution pump 60 to perform cleaning at a target location. When the target location is a sensor cleaning system, the sensor cleaning is performed with the stored cleaning solution. If the target location is a windshield, the windshield cleaning is performed with the stored cleaning solution. In some embodiments, a discharge valve may be provided at a lower portion of the vehicle to discharge excess cleaning solution.

In some embodiments, the cleaning solution supply device 1 according to the present disclosure may be provided outside the silencer 10. In some embodiments, the cleaning solution supply device 1 may be integrated into the silencer 10.

The cleaning solution supply device according to the present disclosure is configured to efficiently utilize residual water of a fuel cell vehicle.

Additionally, the cleaning solution supply device according to the present disclosure may prevent freezing inside a muffler. Since water vapor or water collected inside the muffler is stored in a separate tank, freezing inside the muffler may be inhibited or prevented.

According to the present disclosure, it is possible to avoid or prevent a vehicle accident that may occur in winter when the outside temperature is low. When water generated when the outside temperature is low is sprayed on the road, an icy road may be formed, which may cause a vehicle accident. Further, when the number of hydrogen vehicles on the road increases, the amount of water generated by these vehicles also increases. In this situation, it may be difficult to prevent the vehicle accident on the icy road. The present disclosure is configured to use water generated in the fuel cell vehicle as a cleaning solution, thereby preventing the above-described problems.

In addition, the present disclosure may increase a maintenance cycle for a cleaning liquid needed in a vehicle. In a vehicle of the related art, only windshield cleaning is required, so the consumption of the cleaning liquid is not so significant. However, in case of autonomous vehicles, the number of environmental sensors increases and the number of the sensors that need cleaning also increases, which in turn increases consumption of the cleaning liquid. The present disclosure may solve the problem of insufficient washer fluid in the autonomous vehicle.

The present disclosure is also advantageous for a layout of the vehicle. When the environmental sensors are cleaned using a washer fluid, consumption of the washer fluid increases, so it is required to increase the capacity of an existing tank for the washer fluid. The present disclosure maintains or reduces the capacity of the existing tank through a self-replenishing cleaning system, thereby having an effect of securing the vehicle layout.

As is apparent from the above description, the present disclosure provides a cleaning solution supply device capable of efficiently treating residual water generated in a fuel cell vehicle.

The effect of the present disclosure is not limited to the above-mentioned effect, and other effects not mentioned will be clearly understood by those skilled in the art in detailed descriptions of the embodiments.

The present disclosure has been described in detail with reference to the embodiments thereof. However, it should be appreciated by those skilled in the art that changes may be made to these embodiments without departing from the principles and spirit of the present disclosure.

What is claimed is:

1. A cleaning solution supply device comprising:
a housing;
a mixing pump mounted on the housing and configured to receive water generated during power generation of a fuel cell stack and to mix the water with a cleaning agent stored in the housing; and
a supply line configured to discharge a cleaning solution obtained by mixing the water with the cleaning agent to an outside of the housing.

2. The cleaning solution supply device of claim 1, wherein:
the housing comprises a first space and a second space separated from each other, and
the cleaning agent is stored in the first space.

3. The cleaning solution supply device of claim 2, wherein the second space stores the cleaning solution as mixed by the mixing pump.

4. The cleaning solution supply device of claim 3, further comprising a cleaning solution pump disposed in the second space and configured to pump the cleaning solution to an outside of the second space.

5. The cleaning solution supply device of claim 4, further comprising a cleaning solution filter disposed to surround the cleaning solution pump.

6. The cleaning solution supply device of claim 4, wherein the supply line is connected to an outlet of the cleaning solution pump.

7. The cleaning solution supply device of claim 1, wherein the cleaning solution is directed at a windshield cleaning system or a sensor cleaning system of a fuel cell vehicle comprising the fuel cell stack.

8. The cleaning solution supply device of claim 1, wherein:
the mixing pump comprises a first pump and a second pump,
the first pump is configured to draw the water to move into the housing, and
the second pump is configured to move the cleaning agent into the housing.

9. The cleaning solution supply device of claim 1, wherein the mixing pump is a single mixing pump comprising a first inlet and a second inlet, which are configured to suction the water and the cleaning agent.

10. The cleaning solution supply device of claim 9, further comprising: a directing tube through which the water flows; and a cleaning agent line through which the cleaning agent flows,
wherein the directing tube is connected to the first inlet of the single mixing pump, and the cleaning agent line is connected to the second inlet of the single mixing pump.

11. The cleaning solution supply device of claim 10, wherein the directing tube and the cleaning agent line are configured to have different diameters.

12. The cleaning solution supply device of claim 1, wherein the water is received from a silencer connected to an outlet of the fuel cell stack, and the silencer comprises a water pumping unit configured to move the water.

13. The cleaning solution supply device of claim 8, further comprising a controller configured to control the mixing pump.

14. The cleaning solution supply device of claim 13, further comprising a remainder sensor configured to detect an amount of the cleaning agent and an amount of the cleaning solution in the housing and to notify the controller of the detected amounts of the cleaning agent and cleaning solution.

15. The cleaning solution supply device of claim 14, wherein the controller is configured to drive the mixing pump when the detected amount of the cleaning solution is less than a preset amount.

16. The cleaning solution supply device of claim 15, wherein the controller is configured to provide a notification to a cluster of a fuel cell vehicle comprising the fuel cell stack when the detected amount of the cleaning solution is less than the preset amount even after the mixing pump has been repeatedly driven.

17. The cleaning solution supply device of claim 14, wherein the controller is configured to provide a notification to a cluster of a fuel cell vehicle comprising the fuel cell stack when the detected amount of the cleaning agent is less than a preset amount.

18. The cleaning solution supply device of claim 14, wherein the controller is configured to forcibly discharge the cleaning solution through the supply line when the detected amount of the cleaning solution exceeds a preset upper limit amount.

19. The cleaning solution supply device of claim 13, wherein the controller is configured to vary flow rates of the first pump and the second pump.
